(19) United States
(12) Patent Application Publication
(10) Pub. No.: US 2025/0308354 A1
(43) Pub. Date: Oct. 2, 2025

(54) STAIRWELL SIGNAGE SYSTEM

(71) Applicant: SAFEEVAC, INC., Evansville, IN (US)

(72) Inventors: Michael Lynn Sandefur, Evansville, IN (US); Michael Joseph Day, Evansville, IN (US); Kyle Carter Edmondson, Evansville, IN (US)

(73) Assignee: SAFEEVAC, INC., Evansville, IN (US)

(21) Appl. No.: 19/089,153

(22) Filed: Mar. 25, 2025

Related U.S. Application Data
(60) Provisional application No. 63/570,130, filed on Mar. 26, 2024.

(51) Int. Cl. G08B 7/06

(52) U.S. Cl. CPC G08B 7/066

(57) ABSTRACT

A stairwell signage system includes smart stairwell signs which are placed on landings, preferably, in between floors in a stairwell such that, preferably, a set of three or more lights are visible from above a sign and a set of three or more lights are visible from below a sign. Activation of the lights in different patterns or colors could indicate a hazard and for individuals to avoid the hazard, or indicate a preferred evacuation route and to move toward the sign, or indicate safety and to remain in place, or indicate the direction to the hazard. The smart stairwell signs could alternatively be placed on the side walls in the stairwell. Also, there are circumstances in which a single run of stairs runs between floors with no landings, and the smart stairwell signs could be strategically placed on the stairwell walls. The stairwell signs are preferably controlled as part of a larger smart security or evacuation system. The lights may be strobe lights. The stairwell signs can also include speakers or microphones to communicate with people in the stairwell, or cameras, or other sensors.

### CROSS REFERENCE TO RELATED APPLICATION

This application claims priority to U.S. Provisional Application 63/570,130, filed 26 Mar. 2024, incorporated herein by reference.

### FIELD OF THE INVENTION

A stairwell signage system includes smart stairwell signs which are placed on landings, preferably, in between floors in a stairwell such that, preferably, a set of three or more lights are visible from above a sign and a set of three or more lights are visible from below a sign. Activation of the lights in different patterns or colors could indicate a hazard and for individuals to avoid the hazard, or indicate a preferred evacuation route and to move toward the sign, or indicate safety and to remain in place, or indicate the direction to the hazard.

The smart stairwell signs could alternatively be placed on the side walls in the stairwell. Also, there are circumstances in which a single run of stairs runs between floors with no landings, and the smart stairwell signs could be strategically placed on the stairwell walls.

The stairwell signs are preferably controlled as part of a larger smart security or evacuation system. The lights may be strobe lights. The stairwell signs can also include speakers or microphones to communicate with people in the stairwell, or cameras, or other sensors.

### BACKGROUND OF THE INVENTION

Traditional security systems and emergency evacuation systems include general visual and auditory alarms. However, these alarms typically provide only a general notice that occupants should exit a building or other area. Threats such as fire or active shooters may be located in a specific threat area, and a general notice to exit a facility could inadvertently result in occupants entering the threat area. Typical security systems and emergency evacuation systems do not provide the type and depth of information that occupants may need in order to identify and avoid a threat area, which would be more effective in minimizing exposure to the threat.

The inventors of the present disclosure realized that improvements in security systems and emergency evacuation systems are needed to address the needs of individuals, particularly in stairwells. Certain preferred features of the present disclosure address these and other needs and provide other important advantages.

### SUMMARY

Embodiments of a stairwell signage system include smart stairwell signs which are placed, preferably on landings in between floors in a stairwell such that, preferably, a set of three or more lights are visible from above a sign and a set of three or more lights are visible from below that sign. The lights can be independently activated to display different colors and in different patterns. In preferred embodiments, the smart stairwell signs include one or more groups of three lights arranged in a triangular pattern. Different patterns of light activation are used to indicate safe and unsafe conditions. As different information can be provided to a person looking up at a sign as compared to information provided to another person looking down at that sign, a single sign unit can have a first set of lights which are visible from above and a second set of lights which are visible from below. Alternatively, two units can comprise a sign, a first unit which has a set of lights which would be visible from above and a second unit which has a set of lights which would be visible from below.

More particularly, taught is a stairwell signage system including at least one stairwell sign for placement in a stairwell, the at least one stairwell sign having a housing system containing a first light system viewable from above the housing system, but not from below, and a second light system viewable from below the housing system, but not from above, where each of the first and second light systems have at least one light which can display multiple light colors. At least one of the at least one stairwell sign can be placed on a landing between two adjacent floors. Also, a floor indicator sign can be placed on a landing at a floor to provide information to a person who can see that floor indicator sign.

Each of the first and second light systems can include at least one light source which is in light communications with a shroud, the orientation of each shroud determining where the light source is visible. Either a lens or, in the alternative, a light tube can be provided between each light source and its associated shroud. Also, the housing system contains a face, each shroud extending from the face, the face containing grooves therein, the grooves at least partially or completely surrounding each shroud. The orientation of each shroud can be adjustable to alter where its associated light source is visible. Even further, the at least one light source with each of the first and second light systems, can include at least three light sources, each in light communication with an associated shroud, the three light sources with associated shrouds of the first light source and the three light sources with associated shrouds of the second light source are arranged such each of the three associated shrouds are at a vertex of a triangle which shows on a face of the housing system. Further, at least a down arrow can be located on the face of the housing system generally located between two vertices of the associated triangle forming the base of the triangle, the down arrow having a light source which can illuminate the down arrow. Also, at least an up arrow can be located on the face of the housing system at a location above its associated down arrow, the up arrow having a light source which can illuminate the up arrow.

In addition, each of the at least one stairwell sign can contains a controller, where the controller of each of the at least one stairwell signs can send information to and receive information from an in-house system controller. Also, the in-house system controller can send information to and receive information from an operations center for determining what information is provided by each of the at least one stairwell sign.

Also, each of the first and second light systems can include at least one recessed light source which is received at the base of a recessed opening, the recessed opening creating a light barrier which determines where the light source is visible. The light barrier can terminate at a face of the housing system or the light barrier can extend above a face of the housing system.

The housing system containing a first light system viewable from above the housing system, but not from below, and a second light system viewable from below the housing system, but not from above can have the first light system located on a first unit and has the second light system located on a second unit or have the first and second light systems located on a single unit.

Further, each of the first and second light systems can include at least one light source which is in light communications with a louver, the orientation of each louver determining where the light source is visible.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

Some of the figures shown herein may include dimensions or may have been created from scaled drawings. However, such dimensions, or the relative scaling within a figure, are by way of example only, and are not to be construed as limiting the scope of this invention.

FIG. 1 is a block diagram showing a first embodiment stairwell sign integrated into a stairwell signage system.

FIG. 2 is a diagram of a stairwell in a four story building employing stairwell signs on the landings between floors.

FIG. 3 is a diagram of a stairwell in a four story building employing stairwell signs on the landings between floors and a floor indicator sign on the landing at each floor.

FIG. 4 is a front perspective view of a stairwell sign having a housing system with an up light housing unit and a down light housing unit.

FIG. 5 is a right side view of the stairwell sign of FIG. 4, as shown by the lines 5-5.

FIG. 6 is a perspective view looking toward the front from above the stairwell sign of FIG. 4.

FIG. 7 is a perspective view looking toward the front from below the stairwell sign of FIG. 4.

FIG. 8 is a front view of the right unit of the stairwell sign of FIGS. 4-7.

FIG. 9 shows the cross section portion of the right unit of FIG. 8 along the section lines 9-9.

FIG. 10 is a front perspective view of a second embodiment stairwell sign having a housing system with a single housing unit with both the up light and down light units contained therein.

FIG. 11 is a perspective view looking toward the front from below of a third embodiment stairwell sign having a housing system with a single housing unit with both the up light and down light units contained therein

FIG. 12 is a perspective view of the stairwell sign of FIG. 11 looking toward the sign's front.

FIG. 13 shows the cross section portion of the single unit of FIG. 12 along the section lines 13-13.

FIG. 14 shows an fourth embodiment of a stairwell sign employing fixed or adjustable louvers to limit where the lights behind the louvers can be seen.

FIG. 15 shows the alternative use of lights with Fresnel lenses to control where the lights can be seen rather than using mechanical blocking to control where the lights can be seen, the sign shown in this figure having the lens oriented so that the light can be seen from below the sign.

FIG. 16 shows the cross section portion of the unit of FIG. 15 along the lines 16-16.

FIG. 17 shows an alternative stairwell sign having a 3-part arrow, instead of the 3 light triangle, shown for example in FIGS. 4-7, where the up and down arrows and the connector therebetween can be separately illuminated.

FIG. 18 shows the alternative stairwell sign of FIG. 17 having fixed or adjustable louvers over the 3-part arrow to limit where the arrow can be seen.

FIG. 19 shows a stairwell sign employing two of the 3-part arrow signs of FIG. 17, each 3-part arrow behind a louver set, the louver set on the left allowing the 3-part arrow behind it to be seen only from below and the louver set on the right allowing the 3-part arrow behind it to be seen only from above.

FIG. 20 shows a stairwell sign with a single housing having a pair of 3-part arrow signs. Louver sets, such as shown in FIG. 19, could be employed so that one arrow is seen only from above and the other arrow is seen only from below.

FIG. 21 shows a front perspective view of a stairwell sign having a housing system with a fixed or rotatable shroud, the light from the sign viewable from below, the housing having glare reducing grooves partway around each shroud.

FIG. 22 shows a front perspective view from below of the stairwell sign of FIG. 21, the stairwell sign including a unit which has light viewable from above.

FIG. 23 shows a stairwell sign similar to that of FIG. 21, except the glare reducing grooves extend full around each shroud.

FIG. 24 shows a cross-section view of a portion of the sign of FIG. 23 showing the use of a shroud, lens, and light source.

FIG. 25 shows the same cross-section view as does FIG. 24, except, as an alternative, showing the use of a shroud, light tube, and light source.

### DETAILED DESCRIPTION OF THE ILLUSTRATED EMBODIMENTS

For the purposes of promoting an understanding of the principles of the invention disclosed herein, reference will now be made to one or more embodiments, which may or may not be illustrated in the drawings, and specific language will be used to describe the same. It will nevertheless be understood that no limitation of the scope of the disclosure is thereby intended; any alterations and further modifications of the described or illustrated embodiments, and any further applications of the principles of the disclosure as illustrated herein are contemplated as would normally occur to one skilled in the art to which the disclosure relates. At least one embodiment of the disclosure is shown in great detail, although it will be apparent to those skilled in the relevant art that some features or some combinations of features may not be shown for the sake of clarity.

Any reference to “invention” within this document is a reference to an embodiment of a family of inventions, with no single embodiment including features that are necessarily included in all embodiments, unless otherwise stated. Furthermore, although there may be references to benefits or advantages provided by some embodiments, other embodiments may not include those same benefits or advantages, or may include different benefits or advantages. Any benefits or advantages described herein are not to be construed as limiting to any of the claims.

Specific quantities (spatial dimensions, temperatures, pressures, times, force, resistance, current, voltage, concentrations, wavelengths, frequencies, heat transfer coefficients, dimensionless parameters, etc.) may be used explicitly or implicitly herein; such specific quantities are presented as examples only and are approximate values unless otherwise indicated. Discussions pertaining to specific compositions of matter, if present, are presented as examples only and do not limit the applicability of other compositions of matter, especially other compositions of matter with similar properties, unless otherwise indicated. When used with a numerical value, the terms “about,” “approximately,” “substantially,” or similar terms mean, unless otherwise specified, a range of numerical values within ten percent of the most precise significant digit in the stated value. For example, “about 10” means the range from 9 to 11, while “about 10.0” means the range from 9.9 to 10.1. Similarly, the terms when used with a textual description of a numerical parameter, such as “substantially perpendicular” means an angle within ten percent of 90 degrees to a given surface (e.g., 81 degrees to 99 degrees).

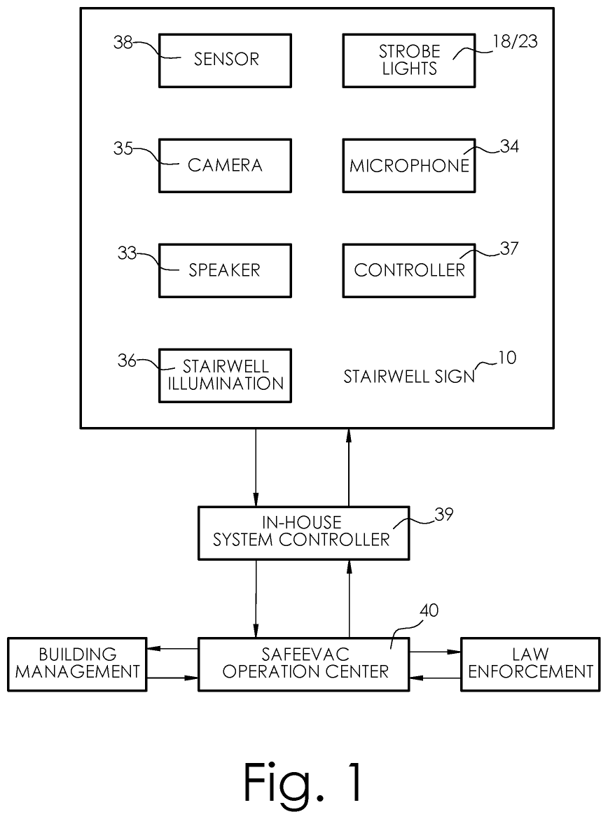

Referring now to FIG. 1, a block diagram of a stairwell signage system is shown being integrated into an in-house system controller 39 and then into a SafeEVAC Operations Center 40. The Stairwell Sign 10 can include a Sensor 38, a Camera 35, a Speaker 33, Strobe lights 18/23, a Microphone 34, a Controller 37, Stairwell Illumination lights 36, all operating as a unit to detect threats and to convey information related to the threat and information related to ingress and egress of the building.

The Stairwell Sign 10 is one sign in a group of signs located throughout a building. Each sign is designed to identify the presence of a threat and to provide visual and audible information to the occupants. Threats could be related to intruders, fire alarms, weather events, or other events where information is needed to be provided to individuals in a building, to first responders, or to others. Upon the identification of a threat from a sign a programmed response will be activated throughout the groups of signs. The programmed response from signs not receiving a threat may be different based on the relevant location to the sign receiving the threat. There are different types of signs relevant to the location in the building and regulatory requirements. In areas where regulatory signs are required the signs will meet regulatory requirements and have the Exit script and directional arrows. In areas where a regulatory Exit sign is not required, a sign may not have the Exit script. In hallway intersections a sign indicating the preferred direction using arrows, strobe, and strobe patterns may be used to identify a threat and provide evacuation information for the occupants.

The strobe pattern and color vary according to the proximity to the identified threat. Preferably, in the immediate vicinity of the threat, a red triangular pattern strobing in a clockwise direction. Preferably, in areas suitable for evacuation, two alternating horizontally aligned green strobes. Preferably, for directing first responders to the threat, a yellow triangular pattern strobing in a counter-clockwise direction. Preferably, for shelter-in-place, a blue triangular pattern strobing from the top single strobe to the bottom two strobes. Preferably, for areas within the immediate threat area, a red triangular pattern strobing in a clockwise direction. Stairwell landing evacuation lighting provides the challenge of needing to convey a comprehensible message to occupants going both up and down the stairs. The preferred methods include the strobing patters described above in this paragraph or arrows utilizing the colors described above in this paragraph.

Sensor 38 is an electrical component, or components, capable of detecting environmental variations, such as, sound, pressure, temperature. Also, a threat can be detected visually, either via artificial intelligence or human monitoring. Environmental variations are processed by the Controller 37 and, if environmental variations exceed or match programmed reference levels, information is sent to the In-House System Controller 39 for additional analysis. If the results of the analysis of the In-House Controller 39 are within normal parameters no further actions are taken. If the results of the analysis of the In-House Controller 39 exceed normal parameters or match programmed reference levels the In-House Controller 39 notifies the SafeEVAC Operation Center 40. Upon notification the Camera 35 and the Microphone 34 will be activated and human resources at the SafeEVAC Operation Center 40 will, through visual and audible conformation, authenticate the presence of a threat. If it is determined no threat exists, the system returns to normal operation. If a threat is identified, the SafeEVAC Operation Center 40 will activate the pre-programmed response specific to the sign initially identifying the threat. Strobe lights 18/23 pursuant to pre-programmed actions will illuminate both color and pattern and the Speaker 33 will activate with a pre-programmed instruction/warning message. Concurrently, notifications will be sent to the Building Management and Law Enforcement of a detected threat event and they will receive visual and audible feed from the SafeEVAC Operation Center 40.

Alternatively, the In-House System Controller 39 receiving the data from the Controller 37, received from the Sensor 38 could directly identify the presence of a threat and activate the Strobe lights 18/23 pursuant to programmed actions illuminating both color and pattern and the Speaker 33.

Alternatively, the In-House System Controller 39 receiving the data from the Controller 37, received from the Sensor 38 from a different sign either in the stairwell or other areas of the building will activate the Strobe lights 18/23 pursuant to programmed actions illuminating both color and pattern and the Speaker 33 of the Stairwell Sign 10.

The Controller 37 has a receiving port to accept electrical power and distribute to the other components of the Stairwell Sign 10. Controller 37 has a receiving port suitable for accepting and sending information from the internet.

Microphone 34 is connected to the Controller 37 and can relay audible sound to human personal at the SafeEVAC Operation Center 40 and human personnel at the SafeEVAC Operation Center 40 can communicate through the Speaker 33.

The Stairwell Illumination light 36 provides visible light to the floor of the stairwell landing to assist in egress and ingress. The Stairwell Illumination light 36 is preferably LED's and is powered through the Controller 37.

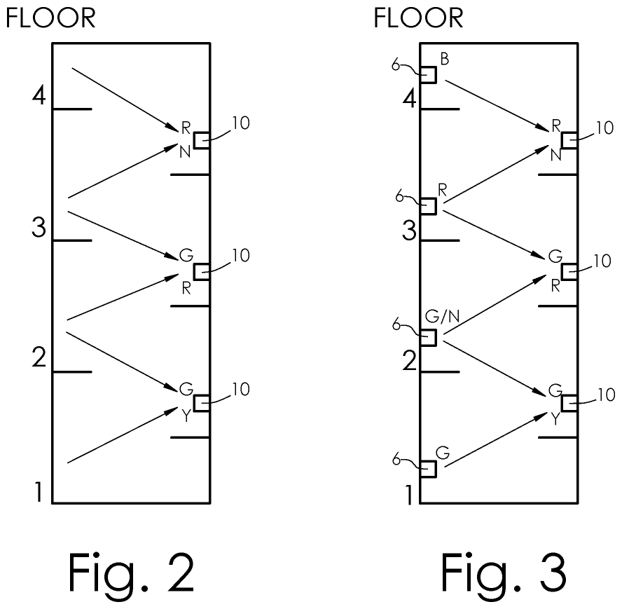

Referring now to FIGS. 2 and 3, the single stairwell of a four floor building is shown. Each floor of the building has a floor landing and there is a mid-floor landing area between the floors where the stairs switch back. In FIGS. 2 and 3, there are three stairwell signs 10, the top sign 10 located above the mid-floor landing between floors 4 and 3, the middle sign located above the mid-floor landing between floors 3 and 2, and the lower sign 10 located above the mid-floor landing between floors 2 and 1. It is noted that the stairs in this building only go down from floor 4, in that there are no steps going up from floor 4 to, for example, roof access. In this scenario, a Threat has been identified on the third floor and it is desired to safely evacuate as many people from the building as possible and to also direct first responders to the Threat. The Threat could compromise the third floor exit. Each stairwell sign 10 has strobe lights 18 which are visible only from above the sign and strobe lights 23 visible only from below the sign.

Looking to FIG. 2, a stairwell in a four story building employing stairwell signs 10 on the landings between floors, personnel on the fourth floor who open the door into the stairwell will look down and see strobe lights 18 on the sign 10 between floors 4 and 3. Those strobe lights 18 will be red, indicating that they should not evacuate down the stairs, but instead remain on the fourth floor. If anyone on the Threat floor 3 does exit into the stairwell, looking up to the sign 10 between floors 3 and 4, strobe lights 23 will not be activated. Looking down to the sign 10 between floors 3 and 2, its strobe lights 18 will be green, telling the person to proceed from floor 3 to floor 2. Anyone evacuating from floor 3 to floor 2 and anyone exiting on floor 2 will look down to down to the sign 10 above the landing between floors 2 and 1, its strobe lights 18 will be green, telling the person to proceed from floor 2 to floor 1 and proceed out of the building. If those people on the floor 2 landing looked up from floor 2 to the landing between floors 2 and 3, the sign 10 there would have its strobe lights 23 illuminated in red cautioning them that the Threat is on the next floor. For first responders headed to the Threat, they would enter the stairwell on the first floor and look up at the sign 10 between floors 1 and 2. They would see yellow strobe lights indicating that is the way to the Threat. When arriving at floor 2, they would and look up at the sign 10 between floors 2 and 3. They would see red strobe lights indicating that the Threat is on the third floor.

Looking to FIG. 3, a stairwell in a four story building employing stairwell signs 10 on the landings between floors and a floor indicator sign 6 on the landing at each floor, personnel on the fourth floor who open the door into the stairwell will look down and see strobe lights 18 on the sign 10 between floors 4 and 3. Those strobe lights 18 will be red, indicating that they should not evacuate down the stairs, but instead remain on the fourth floor. This is reinforced by the floor indicator sign 6 on the fourth floor displays blue light, the blue light indicating stay in place. If anyone on the Threat floor 3 does exit into the stairwell, looking up to the sign 10 between floors 3 and 4, strobe lights 23 will not be activated. Looking down to the sign 10 between floors 3 and 2, its strobe lights 18 will be green, telling the person to proceed from floor 3 to floor 2. The floor indicator light 6 on the third floor reinforces this as it displays red light indicating that there is a Threat on floor 3. Anyone evacuating from floor 3 to floor 2 and anyone exiting on floor 2 will look down to down to the sign 10 between floors 2 and 1, its strobe lights 18 will be green, telling the person to proceed from floor 2 to floor 1 and proceed out of the building. As to the floor indicating light 6 on floor 2, it may be green or not activated, depending on the desired message. If green, it would indicate that a person could enter floor 2. However, with the stated goal of evacuating all possible safely from the building, the preference would be not activated so that people would not want to enter floor 2 but would continue down to the building exit on floor 1. If those people on the floor 2 landing looked up from floor 2 to the landing between floors 2 and 3, the sign 10 there would have its strobe lights 23 illuminated in red cautioning them that the Threat is on the next floor. Upon arrival on floor 1, the floor indicating light 6 on that floor would be a green light indicating that it was safe to enter floor 1 and then exit the building. For first responders headed to the Threat, they would enter the stairwell on the first floor and look up at the sign 10 between floors 1 and 2. They would see yellow strobe lights indicating that is the way to the Threat. When arriving at floor 2, they would and look up at the sign 10 between floors 2 and 3. They would see red strobe lights indicating that the Threat is on the third floor. When arriving at the third floor, the floor indicating light 6 on that third floor landing would also be red indicating that the Threat was on that third floor. It is noted that floor indicator light 6 could be the same as one of the stairwell signs 10 explained hereinafter.

The assignee of this application has a family of evacuation signs which a control system operates so that the signs function together to, for example, assist move people out of a room, move people in hallways away from a threat, move law enforcement officers (LEO) toward a threat, or, with the stairwell sign, move people from floor to floor or out of a building to avoid a threat or move Law Enforcement Officers to any floor where there is a threat.

For signage used in hallways, signage can have multiple sides which can convey different colors from different directions. With stairwells, one face of the sign must be able to convey a non-confusing message to people exiting (going down the stairs) and to first responders entering the same stairwell (going up the stairs).

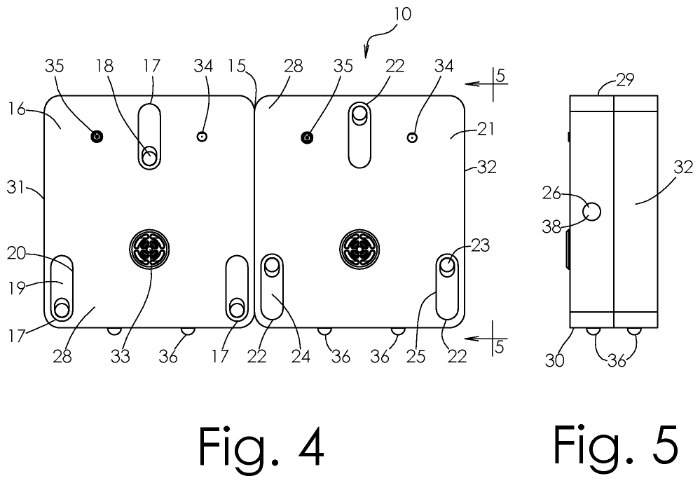

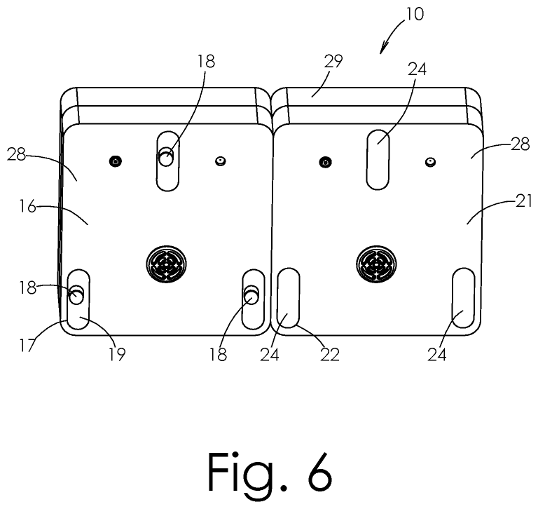

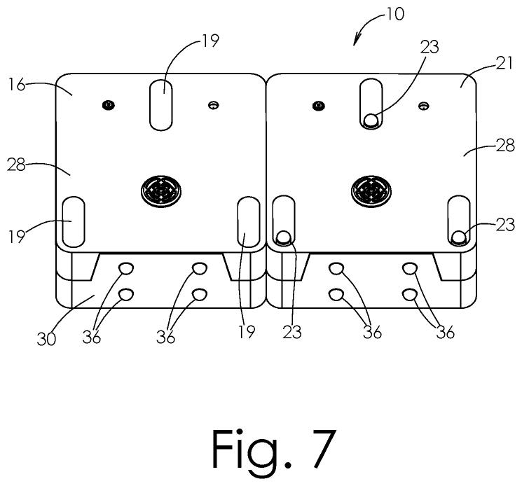

Referring now to FIGS. 4-9, a stairwell sign 10 is shown. The stairwell sign 10 would, preferably, be installed in the switchback landing of a switchback stairwell (between the floors) on the wall (center horizontal) about 8 ft from the landing floor. The sign 10 has a housing system 15 with an up light housing unit 16 and a down light housing unit 21, as shown in sign 10 of FIGS. 4-9, or have single housing unit incorporating both up and down light systems, described later. For this embodiment, as well as with other separate up and down light housing units, it does not matter which up or down light housing unit is on the left or the right of the other. Up light housing unit 16 has a first light system 17 viewable from above the sign 10 but not from below. First light system 17 includes multi-colored strobe lights 18, each strobe light 18 contained in a recess 19 having a light barrier 20 which controls where the strobe 18 can be seen. Down light housing unit 21 has a second light system 22 viewable from below the sign 10 but not from above. Second light system 22 includes multi-colored strobe lights 23, each strobe light 23 contained in a recess 24 having a light barrier 25 which controls where the strobe 23 can be seen. One entering a floor landing in a stairwell could look up and see a stairwell sign on the switchback landing above or look down and see a stairwell sign on the switchback landing below. For signs 10, looking up in the stairwell, one could see any strobe light 23 displays on a down light unit 21, and looking down in the stairwell, one could see any strobe light 18 displays on an up light unit 16.

FIGS. 4-9 show that the up light unit 16 has three recessed strobe lights 18, recessed into housing system 15 from face 28, and the down light unit 21 likewise has three recessed strobe lights 23 recessed into housing system 21 from face 28. These strobe lights 18/23 are placed so that a triangular light pattern can be displayed by each unit 16/21. In addition to face 28, housing system 15 also has a top 29, bottom 30, left side 31, and right side 32. Also shown on face 28 are speaker 33, microphone 34, and camera 35, on bottom 30 are general illumination lights 36, internal to the housing system is controller 37, and right side 32 demonstrates placement of an external sensor port 26 where additional sensors 38, such as, for example, a temperature or pressure sensor can be connected to sign 10. While FIGS. 4-9 show the up light housing unit 16 and a down light housing unit 21 arranged side-by-side, in other embodiments the units 16, 21 may be spaced apart in other embodiments to improve visibility of the down light unit 21 from the floor landing below the unit 21 and improve visibility of the up light unit 16 from the floor landing above the unit 16. When used in stairwells lacking a landing between floors, the units 16, 21 may be positioned along the wall partway down the stairs with their respective faces 28 transverse to the wall and angled to be visible head on by individuals on the stairs.

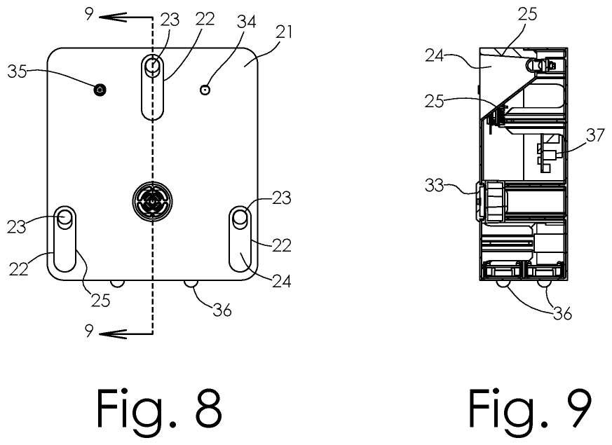

FIG. 8 shows the down light unit 21 and identifies section line 9-9, which section view is seen in FIG. 9. Top center recessed strobe light 23 is seen toward the top of FIG. 9. A light barrier 25, formed by recessed opening 24, controls where light emitted from light 23 can be seen. Looking at FIG. 9, one sees a scalene trapezoid shape with light 23 at the shorter base and the opposed longer base is open for viewing the light. Looking at both FIGS. 8 and 9, to put three dimensions to the light barrier 25, consider forming an oblique cone and, using a plane parallel to the cone's base, cut off the top portion of the cone. That top opening is where the light 23 is received. Then, taking 2 spaced apart planes perpendicular to the cone's base and the plane that cut off the top portion, you would cut off side portions of the cone to create the recessed opening 224 seen in FIGS. 4-8. With light 23 recessed into recessed opening 24, opening 24 causes any light emitted from light 23 to only be seen from below the down light unit 21. The other two lights 23 on the down light unit 21 are similarly situated into recesses 24. For the up light unit 16, the three lights 18 and their recesses 19 are simply 180 degrees from those of down light unit 21, so that their recesses 19 cause any light emitted from lights 18 to be seen from above the up light unit 16. It is noted that the strobe lights 18/23 could utilize and be consistent with the red, green and yellow strobing nomenclature. For example, if a person was on a floor landing, looking up that person might see 3 red strobe lights 23 on down light unit 21 on the switchback landing above and, looking down, might see 3 green strobe lights 18 on up light unit 16 on the switchback landing below. That would indicate to the person that they should proceed down the steps and then repeat the process after arriving on landing of the floor below.

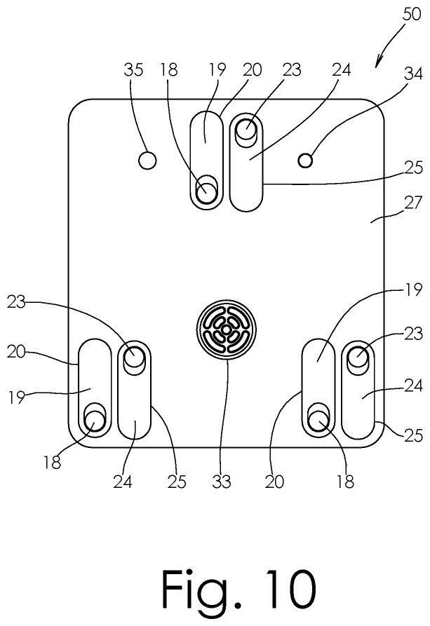

Looking to FIG. 10, a stairwell sign 50 is shown with its housing system being a single up/down housing unit 27. This unit 27 contains 3 multi-colored up light strobes 18 and 3 multi-colored down light strobes 23 in a triangular arrangement, where each up light strobe 18 is adjacent a corresponding down light strobe 23. Up/down light recesses 19/24 and light barriers 20/25, along with speaker 33, microphone 34, and camera 35 are as taught in FIGS. 4-9.

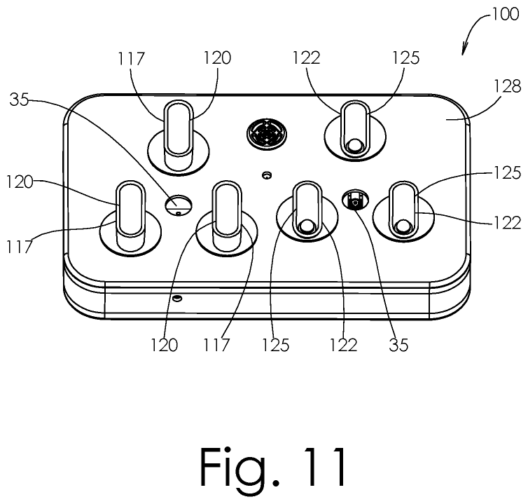

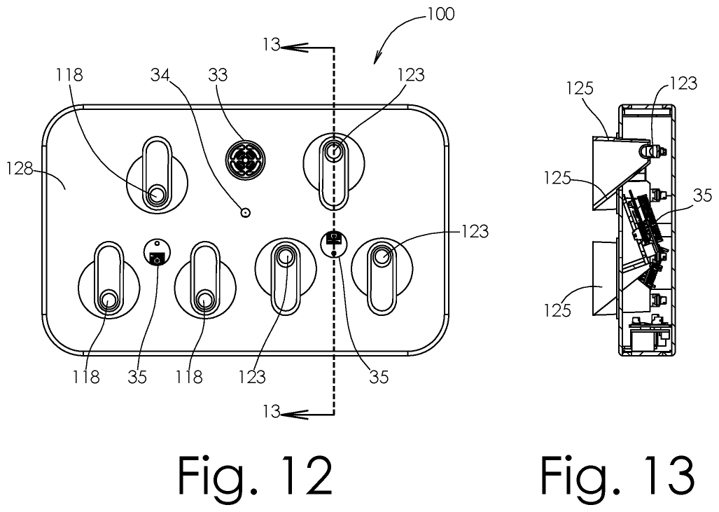

Looking to FIGS. 11-13, a stairwell sign 100 is seen having a first light system 117 viewable from above but not below sign 100 located on the left side of the face 128, and a second light system 122 viewable from below but not above sign 100 located on the right side of face 128. Each of the light systems 117/122 have three strobe lights 118/123 arranged so that the up lights 117 and the down lights 122 each form a triangle. Looking at the section view of FIG. 13, a light barrier 125 is shown with a strobe lights 123. Light barriers 120/125 are similar to light barriers 20/25 shown in FIGS. 4-9 in both shape and function, except the light barriers 120/125 each extend outward beyond face 128 of sign 100. The scalene trapezoid and frustrum of an oblique cone language discussed with sign 10 applies here to sign 100. Also, the previous language of the light barriers 125 for the down lights 122 are 180 degrees from the light barriers 120 for the up lights 117. Speaker 33 and microphone 34 are as previously taught, but sign 100 employs two cameras 35, one more upward looking (on left) and one more downward looking (on right).

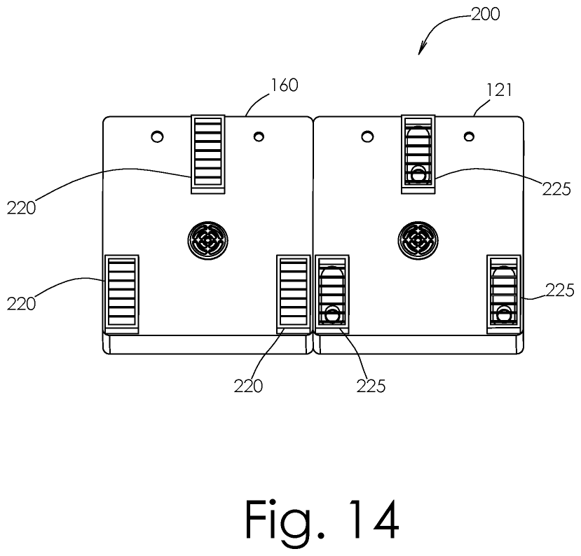

FIG. 14 shows a louvered stairwell sign 200 having an up light housing unit 160 and a down light housing unit 121. Three lights are again placed in a triangular arrangement in the up light housing unit 160 and the down light unit 121 of sign 200. Light barriers would not be necessary with this sign as each light in up light housing unit 160 has a louver 220 placed thereover to permit light to only be seen from above sign 200 and each light in down light housing unit 121 has a louver 225 placed thereover to permit light to only be seen from below sign 200. Units 200 could have fixed louvers or adjustable louvers, as desired for a particular installation.

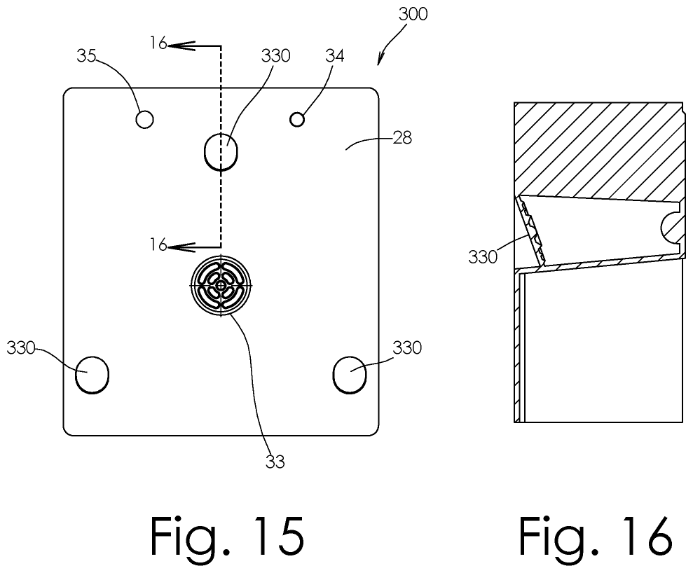

A portion of a stairwell sign 300 is shown in FIGS. 15 and 16 employing a Fresnel lens 330 to direct and shield the light, instead of using light barriers 20/120/25/125 or louvers 220/225. This embodiment is not exhaustive as there are other known apparatus which can focus light in a specific direction.

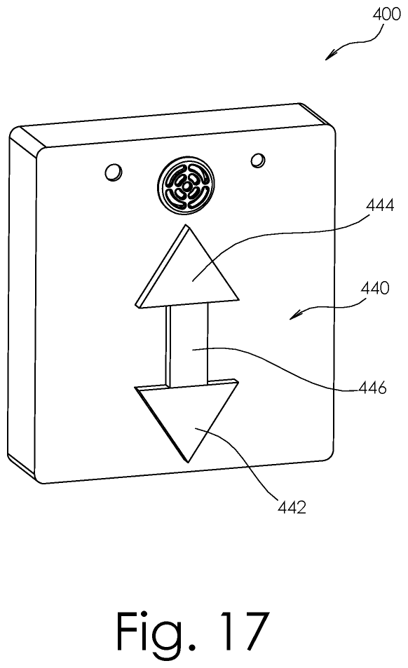

As shown in FIG. 17, a stairwell sign 400 is shown. This sign 400 utilizes a three part arrow 440 which has a down arrowhead 442, an up arrowhead 444 and a connector 446 therebetween. These three parts can be illuminated in different colors. For example, down arrowhead and connector 446 on a sign 400 could be lit in green on a stairwell landing below a person entering the stairwell and up arrowhead 444 and connector 446 could be lit in red on another sign 400 on a stairwell landing above the person entering the stairwell. With that lighting configuration, the person would know that it was safe to go down the stairs to the next floor but not safe to go up.

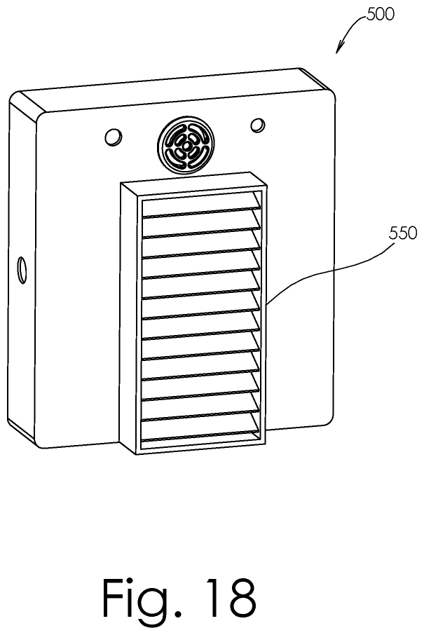

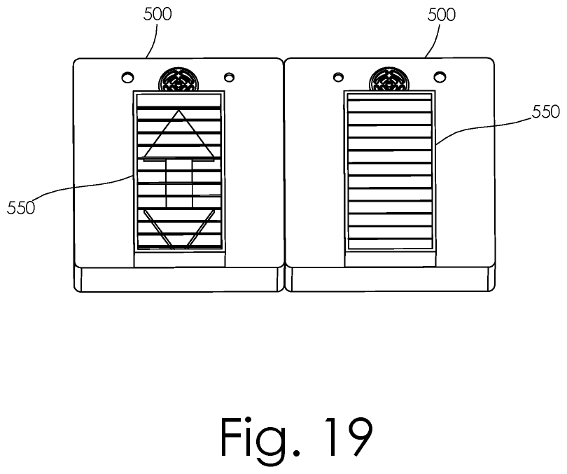

As seen in FIG. 18, stairwell sign 500 is the same as sign 400 except that fixed or adjustable louvers 550 have been added. With this configuration, 2 signs 500 could be placed on the switchback landing between each floor, one sign with the louvers 550 facing up (on right) and one with the louvers 550 facing down (on left), such as seen in FIG. 19. That way, a person entering the stairwell would look down and only see what one of the two signs 500 on the lower landing is displaying and look up and again only see what one of the two signs on the upper landing is displaying. This is similar to the dual unit stairwell sign 10 or the single unit stairwell sign 100 previously described. Instead of using 2 signs 500, a single sign 600, shown in FIG. 20, could be employed. This sign 600 has a pair of 3 part arrows 440 thereon. One arrow 440 could be used for viewing from above and the other arrow 440 could be used for viewing from below. As with previous signs, louvers or other light blocking means could be employed so that individuals looking up or down would only see the arrow 440 which provides them with instructions to follow.

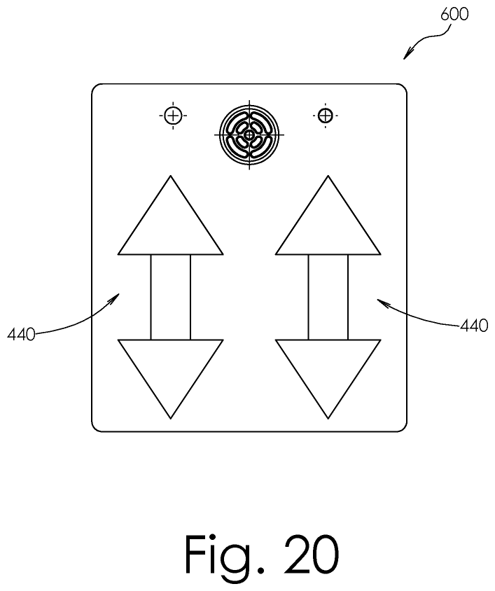

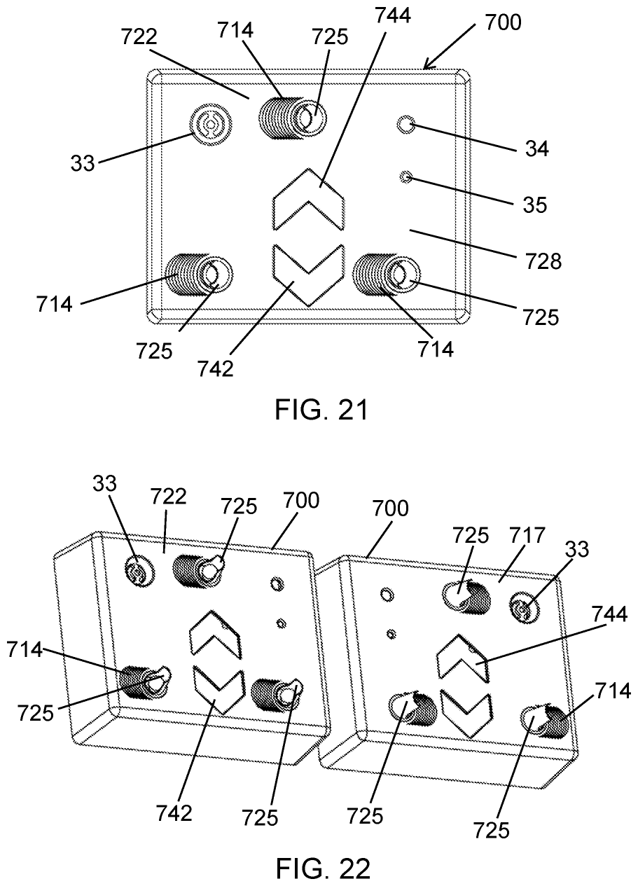

FIGS. 21 and 22 show a stairwell sign 700. In FIG. 21, the unit visible from below is shown and in FIG. 22, the viewable from below unit is shown on the left of the figure and a similar unit viewable from above is shown on the right of the figure. Each unit has a face 728 and may contain a speaker 33, microphone 34, or camera 35 as described with other embodiments. Each unit in sign 700 is shown having three fixed or rotatable shrouds 725 which control where each light can be seen. The viewable from above unit on the right in FIG. 22 has a first light system 717 and the viewable from below unit on the left in FIG. 22 has a second light system 722. Each light system 717/722 preferable employs multi-colored strobe lights, as previously described. In the configuration shown, light systems 717 and 722 each contain three shrouded lights arranged in the shape of a triangle. Other numbers of lights or arrangements of lights can be employed, but, the triangular configuration is preferred, as, when all three lights are activated in red, individuals viewing will visualize a warning sign. Sign 700 also includes a down arrow 742 and an up arrow 744 on the face 728 of each unit, where each arrow 742/744 can preferably also be illuminated in a variety of colors. For example, if a unit was directing a viewer to go down the stairs, the bottom two shrouded lights and the down arrow 742 could all be illuminated in green.

In FIGS. 21 and 22, each shroud 725 is has grooves 714 partway around each shroud 725. Without such grooves 714, the face 728 of each unit could enlarge where each light is visible to include beyond the desired field of view. Grooves 714, for example, either circular grooves or a spiral groove, are designed to help absorb or prevent this unwanted light spread or glare. In FIGS. 21 and 22, grooves 714 encircle about half of the surface around each shroud. FIG. 22 shows grooves 714 toward the left side of each shroud 725 on the left unit viewable from below and toward the right side of each shroud 725 on the right unit viewable from above.

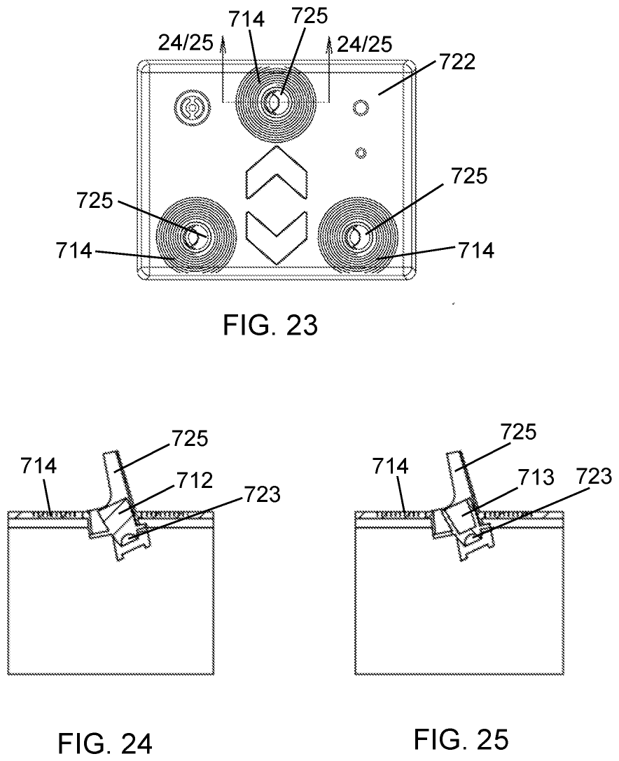

FIG. 23 is similar to the unit of FIG. 21, except that the grooves 714 encircle each shroud 725 a full 360 degrees. FIGS. 24 and 25 show two alternatives for a shroud 725 and its light source 723. FIG. 24 shows a lens 712 placed between the light source 723 and the opening of the shroud 725. In contrast, no lens is employed in the configuration of FIG. 25. There, a light tube 713 is placed between the light source 723 and the opening of the shroud 725.

Reference systems that may be used herein can refer generally to various directions (e.g., top, bottom, leftward, rightward, forward and rearward), which are merely offered to assist the reader in understanding the various embodiments of the disclosure and are not to be interpreted as limiting. It should be understood that the disclosed signage may be mounted at different locations and different orientations with respect to different stairwells, hallways, walls, ceilings, rooms, or other locations. Other reference systems may be used to describe various embodiments.

While examples, one or more representative embodiments, and specific forms of the disclosure, have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used in combination with some or all of the features of other embodiments as would be understood by one of ordinary skill in the art, whether or not explicitly described as such. One or more exemplary embodiments have been shown and described, and all changes and modifications that come within the spirit of the disclosure are desired to be protected.

1. A stairwell signage system, comprising: at least one stairwell sign for placement in a stairwell, the at least one stairwell sign having a housing system containing a first light system viewable from above the housing system, but not from below, and a second light system viewable from below the housing system, but not from above, where each of the first and second light systems have at least one light which can display multiple light colors.

2. The stairwell signage system of claim 1, where at least one of the at least one stairwell sign is placed on a landing between two adjacent floors.

3. The stairwell signage system of claim 1, where a floor indicator sign is placed on a landing at a floor to provide information to a person who can see that floor indicator sign.

4. The stairwell signage system of claim 2, where a floor indicator sign is placed on a landing at a floor to provide information to a person who can see that floor indicator sign.

5. The stairwell signage system of claim 1, where each of the first and second light systems include at least one light source which is in light communications with a shroud, the orientation of each shroud determining where the light source is visible.

6. The stairwell signage system of claim 5, where a lens is provided between each light source and its associated shroud.

7. The stairwell signage system of claim 5, where a light tube is provided between each light source and its associated shroud.

8. The stairwell signage system of claim 5, where the housing system contains a face, each shroud extending from the face, the face containing grooves therein, the grooves at least partially surrounding each shroud.

9. The stairwell signage system of claim 5, where the orientation of each shroud is adjustable to alter where its associated light source is visible.

10. The stairwell signage system of claim 5, the at least one light source with each of the first and second light systems, includes at least three light sources, each in light communication with an associated shroud, the three light sources with associated shrouds of the first light source and the three light sources with associated shrouds of the second light source are arranged such each of the three associated shrouds are at a vertex of a triangle which shows on a face of the housing system.

11. The stairwell signage system of claim 10, where at least a down arrow is located on the face of the housing system generally located between two vertices of the associated triangle forming the base of the triangle, the down arrow having a light source which can illuminate the down arrow.

12. The stairwell signage system of claim 11, where at least an up arrow is located on the face of the housing system at a location above its associated down arrow, the up arrow having a light source which can illuminate the up arrow.

13. The stairwell signage system of claim 2, where each of the first and second light systems include at least one light source which is in light communications with a shroud, the orientation of each shroud determining where the light source is visible.

14. The stairwell signage system of claim 1, where each of the at least one stairwell sign contains a controller, where the controller of each of the at least one stairwell signs can send information to and receive information from an in-house system controller.

15. The stairwell signage system of claim 14, where the in-house system controller can send information to and receive information from an operations center for determining what information is provided by each of the at least one stairwell sign.

16. The stairwell signage system of claim 1, where each of the first and second light systems include at least one recessed light source which is received at the base of a recessed opening, the recessed opening creating a light barrier which determines where the light source is visible, the light barrier terminating at a face of the housing system.

17. The stairwell signage system of claim 1, where each of the first and second light systems include at least one recessed light source which is received at the base of a recessed opening, the recessed opening creating a light barrier which determines where the light source is visible, the light barrier extending above a face of the housing system.

18. The stairwell signage system of claim 1 where the housing system containing a first light system viewable from above the housing system, but not from below, and a second light system viewable from below the housing system, but not from above, and has the first light system located on a first unit and has the second light system located on a second unit.

19. The stairwell signage system of claim 1 where the housing system containing a first light system viewable from above the housing system, but not from below, and a second light system viewable from below the housing system, but not from above, and has the first light system and the second light system located as a single unit.

20. The stairwell signage system of claim 1, where each of the first and second light systems include at least one light source which is in light communications with a louver, the orientation of each louver determining where the light source is visible.
